(19) United States
(12) Patent Application Publication
(10) Pub. No.: US 2025/0194844 A1
(43) Pub. Date: Jun. 19, 2025

(54) AN AUTOMATED FOOD PREPARATION DEVICE AND METHOD THEREOF

(71) Applicant: Varesh Rangan, Fremont, CA (US)

(72) Inventor: Varesh Rangan, Fremont, CA (US)

(21) Appl. No.: 18/937,156

(22) Filed: Nov. 5, 2024

Related U.S. Application Data
(60) Provisional application No. 63/612,244, filed on Dec. 19, 2023.

(51) Int. Cl. A47J 27/00; A47J 36/32; B25J 11/00

(52) U.S. Cl. CPC A47J 27/002; A47J 27/004; A47J 36/321; B25J 11/0045

(57) ABSTRACT

An automated food preparation device is provided. The automated food preparation device includes a refrigeration unit, a pantry unit, a utensils assembly, a robotic arm, an automatic conveyor, a control unit and a heating element. The conveyor transports a plurality of ingredients from one or more of the refrigeration unit and the pantry unit to one or more utensils disposed on a utensil wheel. The automated food preparation device includes utensils to perform at least one task for preparing and cooking food. Further, the utensils attached to a corresponding lid are disposed on each end of an arm in the utensil wheel and rotate about a central spindle. The utensils assembly includes a water pipe adapted to allow hot water to flow. The control unit evaluates the available food ingredients to determine which specific dish or meal to prepare. The element adapted to provide heat to the utensils assembly.

### EARLIEST PRIORITY DATE

This application claims priority from a Provisional patent application filed in the United States of America having Patent Application No. 63/612,244, filed on Dec. 19, 2023, and titled “AN AUTOMATED FOOD PREPARATION DEVICE AND SYSTEM”.

### FIELD OF INVENTION

Embodiments of the present disclosure relate to the field of kitchen appliances, and more particularly, an automated food preparation device and method thereof.

### BACKGROUND

Food, water, and shelter have been essential for the survival of people since the dawn of humanity. Food and water, primarily, have been the most powerful survival tool to every human who has ever existed, even outstripping the need for shelter in certain areas of the world. Since the beginning of recorded time, human beings could, at very minimum, not survive without food and water.

While many questions surround how the earliest humans captured food and found water, we know generally that food began with plants. Human beings could have seen other animals eating plants and tried eating the same plants themselves. Plants became the major forage item for the first humans. At the same time, early humans likely realized that plants were inadequate sustenance for the laborious tasks they performed on a day to day basis.

The next innovation in food came when human beings discovered meat. Humans could have seen other animals killing and eating other animals for meat and tried the meat themselves. At the same time, early humans likely found that raw meat was also inadequate sustenance for them due to the difficulty humans have with digesting raw meat efficiently. In other words, significant available nutrition in raw meat cannot be broken down by human digestion, which means that raw meat also provided inadequate nutrition and energy for survival.

Fire changed humanity in many ways, but likely none more significant than the use of fire for cooking. The cooking of meat unlocked the nutritional content within meat which provided energy and nutrition to early humans that made it possible for humanity not only to survive but also to thrive. While foraging for desirable plants was still important to early humans, meat became the key to performing the arduous work of building shelters, hauling water, and hauling fuel for fire.

As time progressed, humanity began to domesticate animals for food, milk, clothing, and tools derived from animal bones. Agrarian cultures planted desirable plants for feeding people at harvest time. Humanity benefited greatly from the availability of both meat and plants/vegetables in significant supply to provide for themselves, their families, and their communities. In modern day there are few tasks that modern humans do that the first humans did. But one of those tasks is cooking food.

In more recent times, families cook and eat food (or buy cooked food) on a virtual daily basis. However, the process of cooking food after it is collected has also become a fairly laborious task, as it likely always has been. Today, most people are more interested in the taste of their food than in whether or not it is available, which is remarkable when viewed with the perspective of what humanity did for food when the first humans went foraging. Cooking has, therefore, become a hobby for some people, while for others remains a laborious task that takes up a significant portion of the day, time which could be spent enjoying other activities.

The stove and the oven harnessed the power of fire to quicken the amount of time it took to cook food over an open flame. Today, microwave ovens do a significant amount of the cooking for a modern family, heating food that was pre-assembled and bought pre-cooked or par-cooked, ready for warming before consumption. Pre-cooked food has reduced much of the effort cooking previously required but has potentially contributed to other negative externalities such as obesity and other metabolic diseases. In some cases, humanity has traded time saved in cooking for less nutritious food with unknown ingredients. Therefore, a need exists to save time in the cooking process while also providing nutritious food with known ingredients based on the desires of a particular family, or other unit of people.

Hence, there is a need for an automated food preparation device and method thereof which addresses the aforementioned issue(s).

### Objective of the Invention

A primary objective of the present invention is to provide an automated food preparation device that stores food, automatically prepares food and dispenses prepared food ready to eat.

Another objective of the present invention is to provide an automated food preparation device that includes a refrigeration unit, and a pantry unit, and cooking utensils that automatically retrieves food items necessary for the preparation, cooking, and dispensing of food that is ready to eat.

Yet another objective of the present invention is to provide an automated food preparation device that cleans cooking utensils used for cooking.

Yet another objective of the present invention is to provide an automated food preparation device that automatically cleans, cuts and cooks' food.

### BRIEF DESCRIPTION

In accordance with an embodiment of the present disclosure, an automated food preparation device is provided. The automated food preparation device includes a storage unit. The storage unit includes a refrigeration unit adapted to store and maintain a plurality of first ingredients in a cold condition and a pantry unit to store a plurality of second ingredients wherein the plurality of second ingredients are non-perishable. Further, the automated food preparation device includes a utensils assembly. The utensils assembly includes a plurality of utensils attached to a corresponding lid for preparing food pertaining to a distinct cooking approach wherein each of the plurality of utensils are coupled to an arm of a corresponding utensil wheel and rotates about a central spindle, wherein the central spindle is used for performing at least one of grinding, stirring, closing and opening of the lid via a shutter based lid mechanism. The utensils assembly includes a water pipe adapted to allow hot water to flow, wherein the water pipe acts as a frame for supporting the plurality of utensils. Additionally, the utensils assembly includes a spindle hub adapted to allow the plurality of utensil wheels to rotate and tilt around a spindle. The spindle hub also perform an action by the spindle based on a motor positioned in a lid of each of the plurality of utensils. The automated food preparation device includes a robotic arm adapted to stir the plurality of ingredients placed in the plurality of utensils based on a cooking process and also carry one or more of the plurality of utensils from the utensil assembly to a serving point. The automated food preparation device includes a control unit configured to execute on a network wherein the control unit is adapted to determine the food to be prepared based on the plurality of food items, determine one or more meals based on a list of grocery supplies required to prepare the one or more meals, submit a list of required one or more ingredients to a store, wherein the store provides shopping or food delivery services and analyze availability of the one or more ingredients to prepare a food meal by detecting a barcode affixed to each storage location in the storage unit. The automated food preparation device also includes a cooking element adapted to provide heat to the utensils assembly wherein the cooking element comprises a glass induction stove wherein the glass induction stove comprises an electric blade adapted to slide over the surface of the glass induction stove to clean the glass.

In accordance with an embodiment of the present disclosure, a method to operate the automated food preparation unit is provided. The method includes storing and maintaining, by a refrigeration unit of a storage unit, a plurality of first ingredients in a cold condition. The method includes storing, by a pantry unit, a plurality of second ingredients wherein the plurality of second ingredients are non-perishable. The method includes preparing, by a plurality of utensils attached to a corresponding lid, food pertaining to a distinct cooking approach. The method includes allowing, by a water pipe, hot water to flow. The method includes allowing, by a spindle hub, the plurality of utensil wheels to rotate and tilt around a spindle. The method includes performing, by the spindle hub, an action by the spindle based on a motor positioned in a lid of each of the plurality of utensils. The method includes stirring, by a robotic arm, the plurality of ingredients placed in the plurality of utensils based on a cooking process. The method includes carrying, by the robotic arm, one or more of the plurality of utensils from the utensil assembly to a serving point. The method includes determining, by a control unit, the food to be prepared based on the plurality of food items. The method includes determining, by the control unit, one or more meals based on a list of grocery supplies required to prepare the one or more meals. The method includes submitting, by the control unit, a list of required one or more ingredients to a store, wherein the store provides shopping or food delivery services. The method includes analyzing, by the control unit, availability of the one or more ingredients to prepare a food meal by detecting a barcode affixed to each storage location in the storage unit. The method includes providing, by a heating element, heat to the utensils assembly.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a back view of an automated food preparation device in accordance with an embodiment of the present disclosure;

FIG. 2 is a schematic representation of a front view of an automated food preparation device in accordance with an embodiment of the present disclosure;

FIG. 3 is a schematic representation of a canister with a gear to store an ingredient of FIG. 1 in accordance with an embodiment of the present disclosure;

FIG. 4 is a schematic representation of a cooking area with a heating element and utensils of FIG. 1 in accordance with an embodiment of the present disclosure;

FIG. 5 is a schematic representation of a cutting unit of FIG. 1 in accordance with an embodiment of the present disclosure;

FIG. 6 is a schematic representation of a cleaning unit of FIG. 1 in accordance with an embodiment of the present disclosure;

FIG. 7 is a cross sectional view of a utensil for preparing and cooking food of FIG. 1 in accordance with an embodiment of the present disclosure;

FIG. 8 is a box diagram of a utensil wheel for preparing and cooking food of FIG. 1 in accordance with an embodiment of the present disclosure;

FIG. 9 is a schematic representation of a portion of the automated food preparation device of FIG. 1 in accordance with an embodiment of the present disclosure;

FIG. 10 is a schematic representation of an utensil assembly with food dispensers of FIG. 1 in accordance with an embodiment of the present disclosure;

FIG. 11 is a schematic representation of an oil dispenser unit of FIG. 1 in accordance with one embodiment of the present disclosure;

FIG. 12 is a schematic representation of a utensil with a lid of FIG. 1 in accordance with one embodiment of the present disclosure; and

FIG. 13a and FIG. 13b illustrates a flow chart representing the steps involved in a method to operate an automated food preparation device in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation on the scope of disclosure is thus intended. Such alterations and further modifications in the illustrated computer-implemented system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In accordance with an embodiment of the present disclosure, an automated food preparation device is provided. The automated food preparation device includes a storage unit. The storage unit includes a refrigeration unit adapted to store and maintain a plurality of first ingredients in a cold condition and a pantry unit to store a plurality of second ingredients wherein the plurality of second ingredients are non-perishable. Further, the automated food preparation device includes a utensils assembly. The utensils assembly includes a plurality of utensils attached to a corresponding lid for preparing food pertaining to a distinct cooking approach wherein each of the plurality of utensils are coupled to an arm of a corresponding utensil wheel and rotates about a central spindle, wherein the central spindle is used for performing at least one of grinding, stirring, closing and opening of the lid via a shutter based lid mechanism. The utensils assembly includes a water pipe adapted to allow hot water to flow, wherein the water pipe acts as a frame for supporting the plurality of utensils. Additionally, the utensils assembly includes a spindle hub adapted to allow the plurality of utensil wheels to rotate and tilt around a spindle. The spindle hub also perform an action by the spindle based on a motor positioned in a lid of each of the plurality of utensils. The automated food preparation device includes a robotic arm adapted to stir the plurality of ingredients placed in the plurality of utensils based on a cooking process and also carry one or more of the plurality of utensils from the utensil assembly to a serving point. The automated food preparation device includes a control unit configured to execute on a network wherein the control unit is adapted to determine the food to be prepared based on the plurality of food items, determine one or more meals based on a list of grocery supplies required to prepare the one or more meals, submit a list of required one or more ingredients to a store, wherein the store provides shopping or food delivery services and analyze availability of the one or more ingredients to prepare a food meal by detecting a barcode affixed to each storage location in the storage unit. The automated food preparation device also includes a cooking element adapted to provide heat to the utensils assembly wherein the cooking element comprises a glass induction stove wherein the glass induction stove comprises an electric blade adapted to slide over the surface of the glass induction stove to clean the glass.

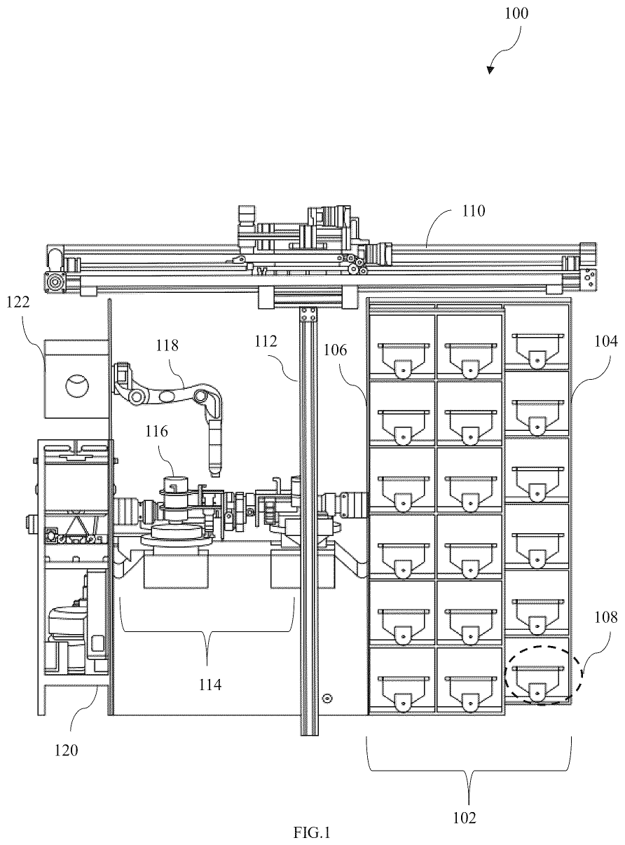

FIG. 1 is a schematic representation of a back view of an automated food preparation device in accordance with an embodiment of the present disclosure. The automated food preparation device 100 includes a storage unit 102. The storage unit 102 includes a refrigerator unit 104 and a pantry unit 106. The refrigerator unit 104 is adapted to store and maintain a plurality of first ingredients in a cold condition ensuring that the plurality of first ingredients stay preserved until it is needed for food preparation. In one embodiment, the refrigerator unit 104 is adapted to store and maintain the plurality of first ingredients in a frozen condition. Likewise, the pantry unit 106 is adapted to store a plurality of second ingredients that are non-perishable. It must be noted that a user provides the plurality of first ingredients and the plurality of second ingredients as desired.

In one embodiment, the refrigeration unit 104 and the pantry unit 106 includes a plurality of canisters 108 wherein each of the plurality of canisters 108 is adapted to store at least one of the plurality of first ingredients and the plurality of second ingredients. It must be noted that the plurality of first ingredients refers to the ingredients stored in the refrigeration unit 104. Likewise, the plurality of second ingredients refers to the ingredients stored in the pantry unit 106.

In one embodiment, the pantry unit 106 includes a cooling section (not shown in FIG. 1) and an ambient section (not shown in FIG. 1). Perishable ingredients are stored in the cooling section and non-perishable ingredients are stored in the ambient section.

In one embodiment, the plurality of first ingredients are moved from the refrigeration unit 104 to the pantry unit 106 to thaw the one or more first ingredients prior to the food preparation process. Likewise, in another embodiment, the plurality of second ingredients are moved from the pantry unit 106 to the refrigeration unit 104 to freeze after the food preparation process is complete.

In another embodiment, the plurality of canisters 108 are held in position and moved along a horizontal and vertical direction by a gantry 110 coupled a vertical bar 112. In such an embodiment, the plurality of canisters 108 are coupled to the vertical bar 112 via a gripper (not shown in FIG. 1). The gripper is coupled to one or more weight sensors to measure the quantity of ingredients taken in the canister. The plurality of canisters 108 are moved from the storage unit 102 to a utensils assembly 114 in a horizontal and vertical direction respectively.

In yet another embodiment, the plurality of canisters 108 is arranged with a gear (not shown in FIG. 1) wherein each rotation of the gear causes a predetermined volume of the ingredient to drop into a corresponding utensil in the utensils assembly 114.

The automated food preparation device 100 includes the utensils assembly 114. Typically, the utensils assembly 114 includes a plurality of utensils 116 attached to a corresponding lid for preparing food pertaining to a distinct cooking approach. Examples of the cooking approach includes, but is not limited to, stirring, grinding, boiling, roasting, frying, stewing, steaming, blanching and sauteing. In other words, the utensil assembly 114 may include a stirrer/mixer unit, a kneading unit, a dough setting unit, a frying unit, and a wrap pressing unit as a non-exhaustive list of the available utensils. The plurality of utensils 116 may be used to perform basic food preparation and cooking tasks, such as stirring rice, making pastas, making wraps, and cooking the food once prepared. Each of the plurality of utensils 116 is coupled to an arm of a corresponding utensil wheel (not shown in FIG. 1). Typically, the utensil wheel helps in positioning or moving the plurality of utensils 116 during the food preparation process. Further, the plurality of utensils 116 rotates about a central spindle (not shown in FIG. 1) wherein the central spindle is used for performing at least one of grinding, stirring, closing and opening of the lid via a shutter based lid mechanism. The central spindle acts as a core axis. The plurality of utensils 116 rotates around this central spindle. The rotation facilitates smooth operation of the plurality of utensils, ensuring that the plurality of utensils perform its tasks effectively.

In one embodiment, the central spindle is controlled by a speed motor operated lid adapted to prevent spillage of the food from the plurality of utensils 116.

The automated food preparation device 100 includes a water pipe (not shown in FIG. 1) adapted to allow hot water to flow. The hot water is used for several purposes such as cooking, cleaning, or preparing the food that requires hot water, like boiling or steaming. Additionally, the water pipe acts as a frame as a frame for supporting the plurality of utensils 116.

The automated food preparation device 100 includes a spindle hub (not shown in FIG. 1) adapted to allow the plurality of utensil wheels to rotate and tilt around a spindle. This allows for flexible movement of the plurality of utensils, likely to accommodate different angles or actions needed for food preparation. Additionally, the spindle hub is adapted to perform an action by the spindle based on a motor positioned in a lid of each of the plurality of utensils. In other words, the spindle hub is also responsible for coordinating actions performed by the spindle. These actions are influenced by a motor located in the lid of each utensil. So, each utensil has its own motor in its lid, which drives specific functions based on what is needed for a particular cooking task.

The automated food preparation device 100 includes a robotic arm 118 adapted to stir the plurality of first ingredients and the plurality of second ingredients placed in the plurality of utensils 116 based on a cooking process. The stirring action is determined by the requirements of a particular cooking process. Therefore, the robotic arm 118 changes its movements and actions depending on what is needed to properly mix or stir the ingredients for a specific recipe or step in the cooking process.

Additionally, the robotic arm 118 is also adapted to carry one or more of the plurality of utensils 116 from the utensil assembly 114 to a serving point (not shown in FIG. 1). Typically, after the cooking process or a particular task (such as stirring, grinding and so on) is completed, the robotic arm 118 can transport the utensils, containing food or ingredients to another location, possibly for serving, adding water, oil or for further processing.

Further, the robotic arm 118 is adapted to stir, add ingredients, hold the utensil, open and close the lid of the utensil and clean the utensil with hot water. These functionalities are supported by grippers which is further explained.

In one embodiment, the robotic arm 118 is coupled with a plurality of arms with grippers. For instance, the robotic arm 118 may have 6 arms with grippers. In such an embodiment, the grippers are adapted with multiple functionalities. For instance, the gripper may be adapted with a scooper to scoop the ingredients from the canister. The scooper may also be adapted to pick up a utensil and tilt it to remove excess water. In another instance, a rotary based gripper may be adapted to rotate the stirring and lid positioned in the central spindle of the lid. It must be noted that such an embodiment is utilized when there is no space constraint in an environment where the automated food preparation device 100 is deployed. However, in the presence of space constraint, the spindle based design for holding and rotating the plurality of utensils is used.

The automated food preparation device 100 includes a control unit (not shown in FIG. 1) configured to execute on a network (not shown in FIG. 1). In one embodiment, the network may include a wired network such as a local area network (LAN) or Wide Area Network (WAN), such as the Internet. In another embodiment, the network may include both wired and wireless communications according to one or more standards and/or via one or more transport mediums. In one example, the network may include wireless communications according to one of the 802.11 or Bluetooth specification sets, or another standard or proprietary wireless communication protocol. In yet another embodiment, the network may also include communications over a terrestrial cellular network, including, a global system for mobile communications (GSM), code division multiple access (CDMA), and/or enhanced data for global evolution (EDGE) network.

The control unit is adapted to determine the food to be prepared based on the plurality of first ingredients and the plurality of second ingredients and one or more constraints specified by the user. The control unit is designed to identify which food needs to be prepared based on the plurality of first ingredients and the plurality of second ingredients available in the storage unit. In other words, the control unit is configured to analyze the ingredients at its disposal and decide what dish or dishes can be made. Further, the one or more constraints refers to restrictions of the user. For instance, the constraint may be don't use onion, don't mix honey and milk. In one embodiment, the user may also input his/her preferences, for instance, Mexican food, Italian food or Indian food and so on. Additionally, the control unit is adapted to determine one or more meals based on a list of grocery supplies required to prepare the one or more meals. In one embodiment, the user is allowed to either to create his/her own recipes, reuse an existing recipe, or ask to create recipes based on the available ingredients (using a GenAI algorithm). Typically, the control unit can assist with meal planning by suggesting recipes or meals based on available ingredients. Further, the control unit is adapted to submit a list of required one or more ingredients to a store, wherein the store provides shopping or food delivery services. The control unit can automate the ordering process for any additional ingredients that is not available in the storage unit. Furthermore, the control unit is adapted to analyze availability of the one or more ingredients to prepare a food meal by detecting a barcode affixed to each storage location in the storage unit. The analysis may be performed on a daily basis to ensure availability of the plurality of ingredients required to prepare the food in future (for instance, a day ahead, two days ahead, a week ahead). Basically, the inventory is tracked to identify what ingredients are present and which ones may need to be ordered or restocked.

In one embodiment, the control unit is adapted to determine the food to be prepared based on the availability of the plurality of first ingredients and the plurality of second ingredients stored in the storage unit. In another embodiment, the user is allowed to determine the food to be prepared based on preference.

In one embodiment, the control unit may be is equipped with advanced microprocessors and software algorithms, enabling it to perform the aforementioned functions.

Further, the automated food preparation device includes a cooking element (not shown in FIG. 1) adapted to provide heat to the utensils assembly to cook the required food. It must be noted that the cooking element is a heating element. Cooking element may be implemented independently from or as part of utensil assembly to provide a cooking unit with utensil assembly and may further access water through a water pipe and dispose of water through a drainage unit.

Further, the cooking element includes a glass induction stove wherein the glass induction stove comprises an electric blade adapted to slide over the surface of the glass induction stove to clean the glass helping to remove any food residue or stains that may occur during cooking. This feature enhances the convenience of maintaining the cooking surface, ensuring it remains clean and functional. The cooking element is designed specifically to supply heat to the utensils assembly, which is essential for cooking processes. This ensures that the utensils can perform their intended functions, such as cooking or warming the ingredients. Further, the induction stove use electromagnetic energy to directly heat the utensils, making them efficient for cooking. The glass surface provides a smooth, easy-to-clean area for placing utensils.

It will be appreciated to those skilled in the art that the cooking element may include a heater for heating water, an oven element, a stove element or any other heating element known in the art for heating food.

In one embodiment, the automated food preparation device further comprises a human machine interface (HMI) monitor (not shown in FIG. 1) adapted to allow a user to provide an input representative of the plurality of first ingredients and the plurality of second ingredients that are to be stored in the storage unit. Typically, the HMI monitor is a display or screen (touch-enabled) that facilitates communication between the user and the automated food preparation device 100. The HMI monitor is specifically adapted to allow the user to provide input regarding the plurality of first ingredients and the plurality of second ingredients that are to be stored in the storage unit. These ingredients can be used for meal planning, inventory management, or other automated cooking processes.

Additionally, the automated food preparation device 100 is configured to allow a user to place an order for a food at a predefined time via the HMI monitor.

Further, the automated food preparation device 100 includes a cleaning unit 120 adapted to clean the plurality of canisters 108.

Furthermore, the automated food preparation device 100 includes a cutting unit 122 adapted to mince the plurality of first ingredients and the plurality of second ingredients.

Moreover, the automated food preparation device 100 includes the drainage unit (not shown in FIG. 1) adapted to collect excess water from the plurality of utensils 116 during the food preparation process and the cleaning process.

Additionally, the automatic food preparation device 100 may further include a plurality of food dispensers (not shown in FIG. 1). For example, the automatic food preparation device 100 may prepare noodle soup with a chicken teriyaki wrap and a side of broccoli. Noodle soup may be prepared by utensils in a first utensil wheel and dispensed through one of food dispensers while the chicken teriyaki wrap may be prepared by utensils in a second utensil wheel and dispensed through one of food dispensers, while the side of broccoli may be prepared by utensils in a third utensil wheel and dispensed through one of food dispensers.

In one embodiment, the automated food preparation device 100 includes a conveyor belt (not shown in FIG. 1) adapted to transport the plurality of first ingredients and the plurality of second ingredients from the storage unit 102 to the one or more utensils 116 for a food preparation process. The conveyor belt is also used to transport the prepared food to a plurality of food dispensers. It must be noted that the gantry 110 is used for transporting the plurality of canisters having ingredients.

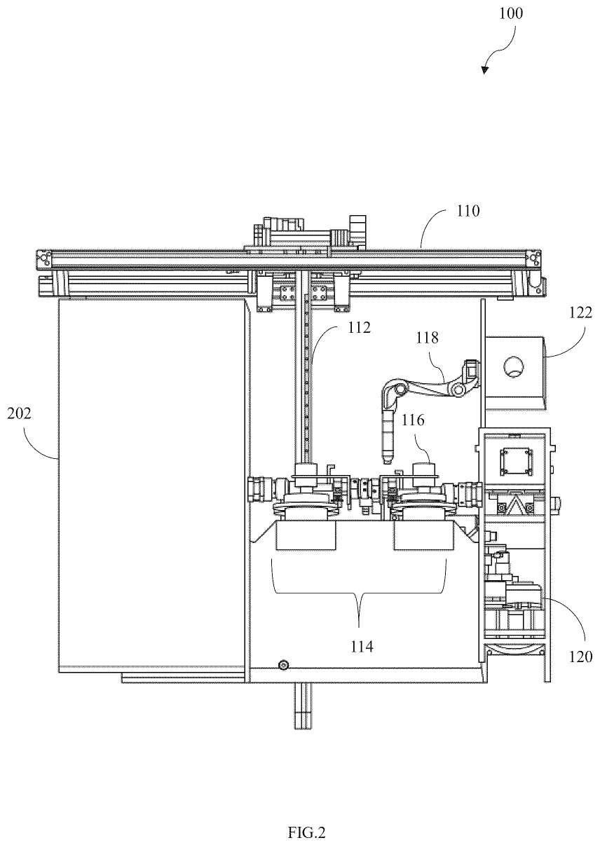

FIG. 2 is a schematic representation of a front view of an automated food preparation device in accordance with an embodiment of the present disclosure.

The front view illustrates the human machine interface (HMI) monitor 202. The HMI monitor 202 is specifically adapted to allow the user to provide an input regarding the plurality of first ingredients and the plurality of second ingredients that are to be stored in the storage unit 102. The HMI monitor 202 allows the user to communicate and control the automated food preparation device. Examples of the input includes, but is not limited to, a list of ingredients, quantity or type of food (for instance, fresh or frozen), preferences for specific recipes or cooking methods. This input is used by the automated food preparation device to manage inventory, plan meals, and automate cooking processes.

Further, the HMI monitor 202 allows the user to customize settings or preferences, such as selecting a recipe, specifying dietary restrictions, or choosing a cooking method (for instance frying, boiling and so on). In one embodiment, the HMI monitor 202 allows the user to choose the portion sizes or the number of servings that he/she wants the automated food preparation device 100 to prepare.

Typically, the HMI monitor 202 consists of a touchscreen or a digital display that is designed to be intuitive and easy for the user to operate. The user is allowed to provide information about the ingredients they want to store in the device's storage unit.

In one embodiment, the automated food preparation device 100 may automatically deploy the correct storage unit 102 for the ingredient to be stored in the refrigeration unit 104 or the pantry unit 106.

In another embodiment, the HMI monitor 202 can display real-time updates to the user, such as the current status of a dish being prepared, cooking times, or alerts if ingredients are running low. In such an embodiment, the progress of various steps, such as chopping, stirring, or heating is also displayed.

In yet another embodiment, the HMI monitor 202 could potentially integrate with smart home systems or external devices, like mobile phones or tablets, allowing users to control the food preparation device remotely. It must be noted that the HMI monitor 202 is also configured to connect with online services, such as grocery delivery platforms, to manage ingredient supplies.

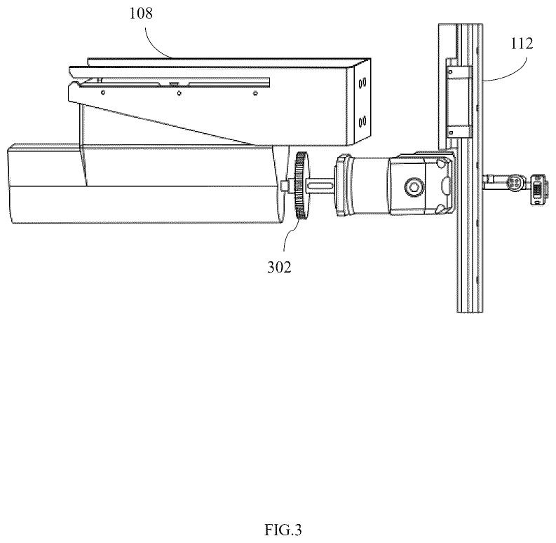

FIG. 3 is a schematic representation of a canister with a gear to store an ingredient of FIG. 1 in accordance with an embodiment of the present disclosure. Each rotation of the gear 302 causes a predetermined volume of the ingredient to drop into a corresponding utensil. The rotation of the gear 302 controls the quantity of the ingredient being dispensed, ensuring accuracy and consistency. Therefore, the ingredients are automatically transferred from the canister 108 to the utensil as needed for a recipe or cooking process. In one embodiment, the canister 108 may be in rectangular in shape.

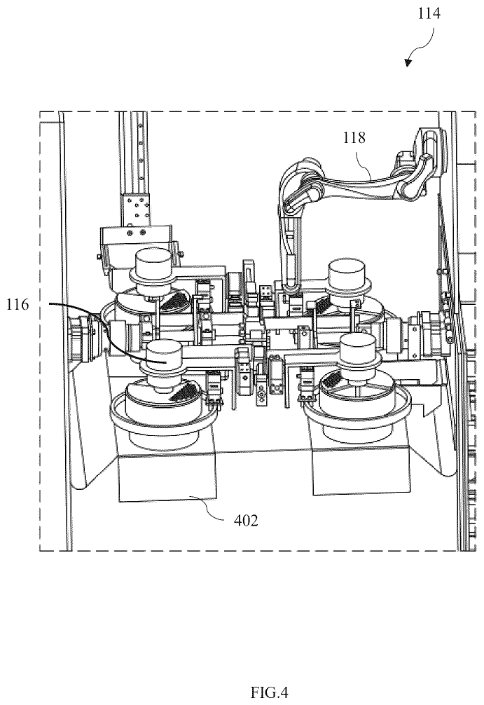

FIG. 4 is a schematic representation of a cooking area with a heating element and utensils of FIG. 1 in accordance with an embodiment of the present disclosure. Typically, the cooking area includes the heating element 402 and the plurality of utensils 116. The heating element 402 is adapted to provide heat to the plurality of utensils for cooking purposes.

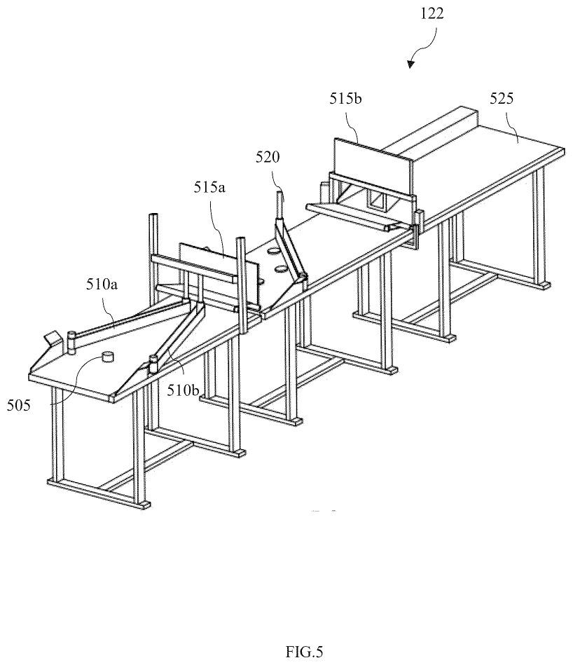

FIG. 5 is a schematic representation of a cutting unit of FIG. 1 in accordance with an embodiment of the present disclosure. The cutting unit 122 is adapted to mince the plurality of first ingredients and the plurality of second ingredients. Additionally, the cutting unit 122 is adapted to cut the ingredients in different shapes and sizes, such as slices, dices and cube shapes. In one embodiment, the ingredients are minced to store the ingredients in a grinded texture.

The ingredient 505 to be minced are pushed forward by a plurality of first conveyor belts 510a, 510b. A first blade 515a cuts the ingredients 505 into slices. A second conveyor belt 520 allows the sliced ingredient 505 to move into a canister for further use. If the ingredient 505 is further required to be sliced, chopped or diced, then the second conveyor belt 520 pushes the ingredient 505 through a second blade 515b. It must be noted that the ingredient 505 is placed on a conveyor belt 525.

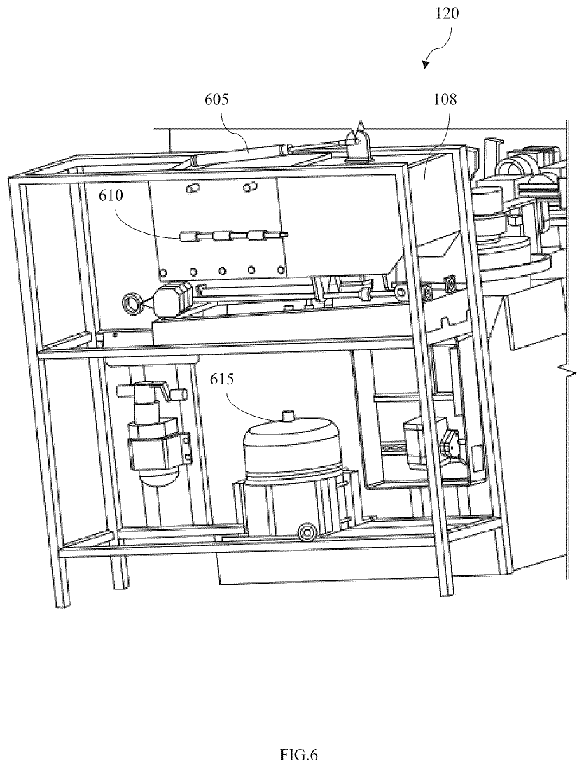

FIG. 6 is a schematic representation of a cleaning unit of FIG. 1 in accordance with an embodiment of the present disclosure. The cleaning unit 120 is adapted to clean the plurality of canisters post the cooking process. The cleaning unit 120 includes a shutter 605 to allow a canister 108 to be placed inside the cleaning unit 120. Multiple sprays 610 are adapted to throw hot water and hot air into the canister 108 for cleaning purposes. The cleaning unit 120 also includes a heater 615 to provide the hot water.

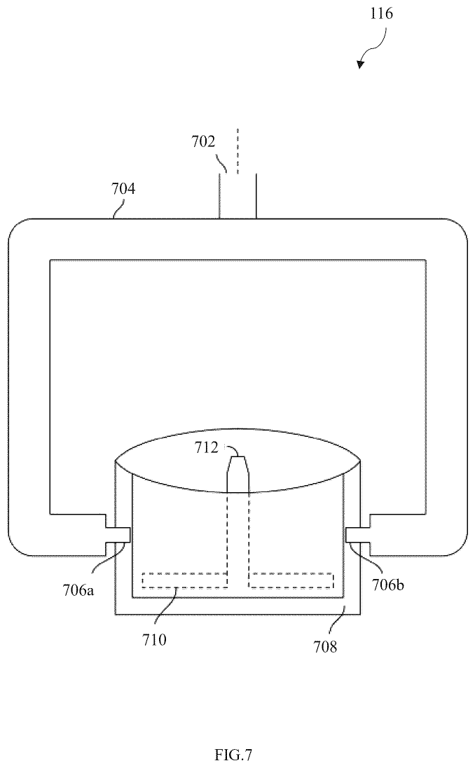

FIG. 7 is a cross sectional view of a utensil for preparing and cooking food of FIG. 1 in accordance with an embodiment of the present disclosure. The utensil 116 includes a water input 702 which feeds a water pipe 704 which performs two different functions. The water pipe 704 serves as a frame for supporting a weight of the utensil 116 while allowing hot water to flow through water pipe 704.

In one embodiment, the hot water may flow through pivot points 706a and 706b via utensil pipe 708 to heat food within the utensil 116. For example, a soup may be disposed within the utensil 116 and may be slowly mixed by mixer 710 within bowl 712 while the hot water flows through water pipe 704 and utensil pipe 708 to heat the soup within bowl 712. The 710 mixer may prevent food within the soup, such as noodles, rice, meat, or vegetables, for example, from burning in 10 the bottom of bowl 712. At the same time, the mixer 710 may facilitate even heating of the soup within bowl 714 as the mixer 710 stirs the soup. In other words, heated water may flow through in a closed loop to provide heating for food within bowl 712. In another embodiment, the hot water, may provide steam through the closed loop to provide heating for food within bowl 712.

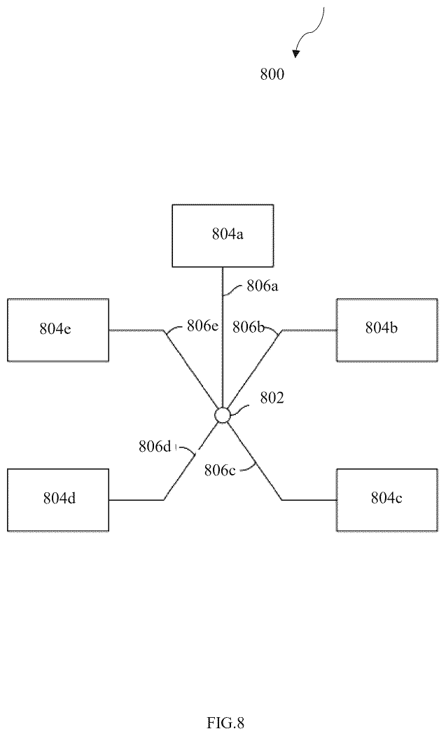

FIG. 8 is a box diagram of a utensil wheel for preparing and cooking food of FIG. 1 in accordance with an embodiment of the present disclosure. A utensil wheel 800 may be one of a plurality of utensil wheels in utensil assembly 114, discussed above with respect to FIG. 1. The utensil wheel 800 may include a spindle hub 802 to which each one of utensils 804a, 804b, 804c, 804d and 804e are connected. The spindle hub 802 may be implemented as a water pipe which feeds water pipes 806a, 806b, 806c, 806d and 806e which are respectively connected to utensils 804a, 804b, 804c, 804d and 804e. In this manner, hot water may be circulated through utensils 804a, 804b, 804c, 804d and 804e as desired. Each one of utensils 804a, 804b, 804c, 804d and 804e may spin around spindle 802 and tilt to convey food from one utensil to another. For example, if utensil 804a is a mixing utensil, it may receive flour, water, and eggs to mix into pasta dough. The spindle 802 may be used for grinding, mixing, or stirring, based on a motor disposed within a lid for utensils 804a, 804b, 804c, 804d and 804e. The utensil 804a may then tilt on pivot points 706a and/or 706b, shown in FIG. 7, to dump the pasta dough into a pasta cutting utensil 804b. The pasta cutting utensil 804b may cut the pasta and tilt to dump the cut pasta into boiling water in cooking utensil 804c and so on, eventually communicating the prepared food to one of dispensers.

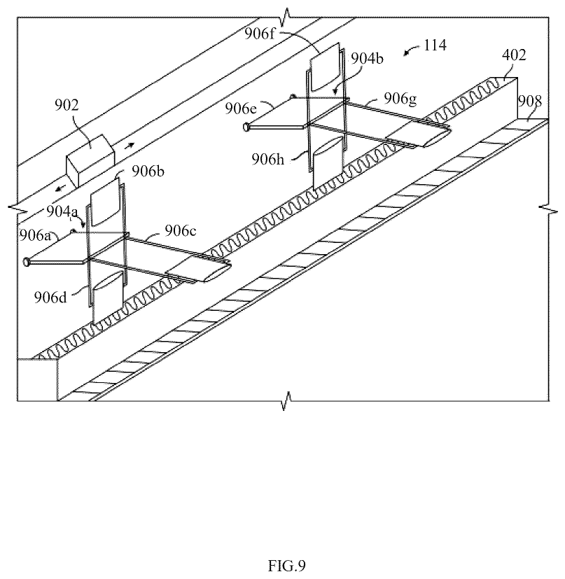

FIG. 9 is a schematic representation of a portion of the automated food preparation device 100 of FIG. 1 in accordance with an embodiment of the present disclosure. As shown in FIG. 9, various elements of the automated food preparation device 100 are provided to illustrate at least one embodiment. FIG. 9 includes a conveyor system 902, and utensil assembly 114 which includes two separate utensil wheels, 904a and 904b as part of cooking system. One of utensil wheels 904a includes four utensils 906a, 906b, 906c and 906d attached to a one of a plurality of utensil wheels and another one of utensil wheels 904b includes four utensils 906e, 906f, 906g and 906h which may be similar in implementation and description to FIG. 7 and FIG. 8, discussed above where each utensil may be similar to utensil 116 shown in FIG. 7 (although performing a different function) and each utensil wheel may be similar to utensil wheel 800 shown in FIG. 8.

FIG. 9 further illustrates a drain channel 908 to allow water to drain out of utensils 906a-906h and the conveyor 902 for serving food through dispensers (not shown in FIG. 9). The conveyor 902 may supply ingredients from refrigeration unit 104 and pantry unit 106 to the utensil wheels 904a and 904b, which may, via various utensils, prepare and cook food using the techniques described above. The food contents of the utensil wheels 904a and 904b, may be communicated from utensil to utensil by tipping the utensil to pour or dump food into the next utensil. A heating element 402 may provide a secondary cooking surface for cooking food in utensil wheels 904a and 904b. Refuse and used water may be disposed in drain channel 908, which allows the water to be drained away from the automated food dispenser device 100.

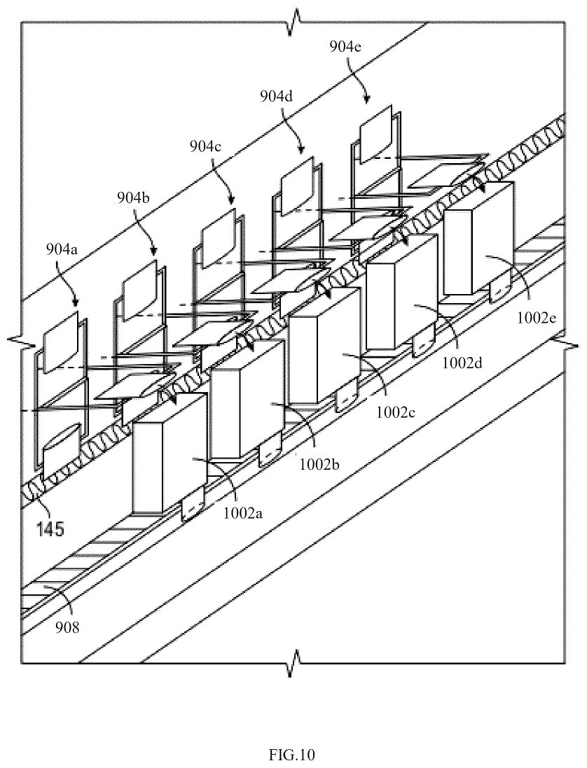

FIG. 10 is a schematic representation of an utensil assembly with food dispensers of FIG. 1 in accordance with an embodiment of the present disclosure. FIG. 10 illustrates an interface of utensil wheels 904a, 904b, 904c, 904d and 904e with the food dispensers 1002a,1002b,1002c,1002d and 1002e in the automated food dispenser device 100. As shown in FIG. 10 each of utensil wheels 904a-904e interact with food dispensers 1002a-1002e to convey cooked food from one of utensil wheels 904a-904e into a corresponding one of food dispensers 1002a-1002e. The drain channel 908 may allow food that has spilled or cooking water or other refuse to be drained into a sewer connection provided with the automated food dispenser device 100. Each of utensil wheels 904a-904e includes a tilting mechanism, discussed above, for each utensil that allows the utensil wheel to drop food into a corresponding one of food dispensers 1002a-1002e.

In practice, the automated food dispenser device 100 may prepare a plurality of dishes at once. For example, as shown in FIG. 10, having an exemplary number of 5 utensil wheels, each one of utensil wheels may prepare a different dish for a meal or may work with another wheel to prepare another dish. For example, one wheel may prepare pasta which can then be used by another wheel to prepare mushroom stroganoff while another wheel makes chicken noodle soup from the same pasta. Another wheel may steam broccoli while another wheel prepares a chocolate pudding. In this manner, one wheel prepares pasta, another wheel prepares mushroom stroganoff, another wheel prepares chicken noodle soup, another wheel prepares broccoli, and another wheel prepares pudding such that each wheel is used in preparing 4 dishes for a meal. The food is conveyed from each wheel respectively into the corresponding one of dispensers 1002a-1002e for dispensing food to hungry eaters.

It is noted that one feature of automated food preparation device 100 is that one cooking technique that may be used is based on a technique called “soak and cook” in which certain ingredients such as rice, grains, beans, lentils, and etc., will be soaked and drained off before applying heat. Soaking and draining these ingredients prior to applying heat reduces power requirements by two fold by cutting cooking time in half. Such a technique improves on pressure cooking due to preservation of nutrients in the food with the “soak and cook” method of cooking. The food may also be considered more palatable and desirable with the “soak and cook” method than with a pressure cooker. It is also possible that these techniques may be used for marinating certain foods within the automated food preparation device 100.

The automated food preparation device 100 may further incorporate allergen aware food storage, in that food for which known allergens exist may be kept and stored separately from other foods. The automated food preparation device 100 may further use hot water to self-clean cooking elements and utensils without the need for chemical solvents, cleaners, or sterilization agents.

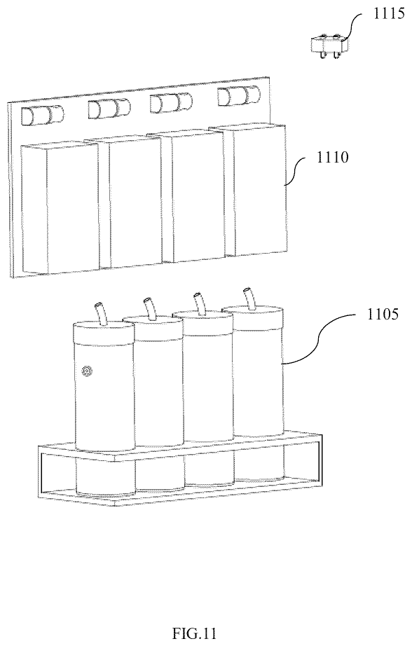

FIG. 11 is a schematic representation of an oil dispenser unit of FIG. 1 in accordance with one embodiment of the present disclosure. The oil dispenser unit 1100 includes a plurality of oil containers 1105 coupled to a plurality of corresponding pumps 1110. Further, the plurality of pumps 1110 are coupled to an oil dispenser 1115.

The plurality of pumps 1110 is adapted to extract a predetermined amount of oil from the plurality of oil containers 1105 and subsequently passes it to the oil dispenser 1115. From the oil dispenser 1115, the oil is transported to the required utensil to prepare the food meal.

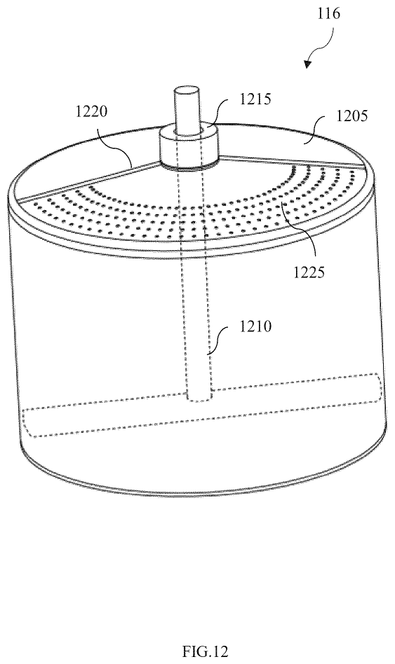

FIG. 12 is a schematic representation of a utensil with a lid of FIG. 1 in accordance with one embodiment of the present disclosure. The utensil includes a lid 1205 with a shutter-based mechanism, a stirring unit 1210. The lid 1205 is coupled to a ring structure 1215 to create a co-axial mechanism wherein rotation of the ring structure 1215 causes the lid 1205 to open and close at an angle of 180 degrees. Further, the lid 1205 includes a shutter 1220 to stop the lid 1205 to move beyond the said 180 degrees. When the lid 1205 is opened, an additional layer is uncovered. The additional layer includes concentric holes 1225 to allow water or any other fluid to pour out of the utensil when tilted. Additionally, the concentric holes 1225 may also be adapted to allow steam to escape out of the utensil. The stirring unit 1210 is adapted to stir the ingredients inside the utensil.

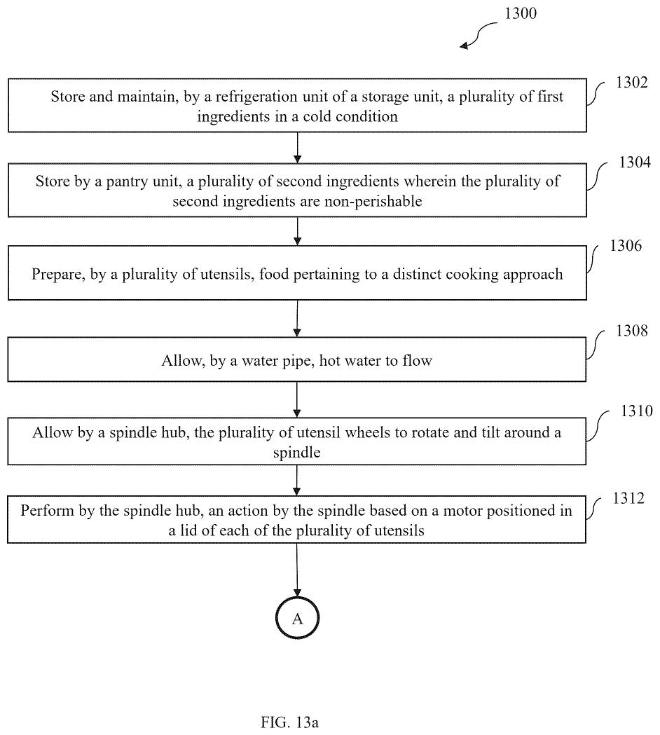

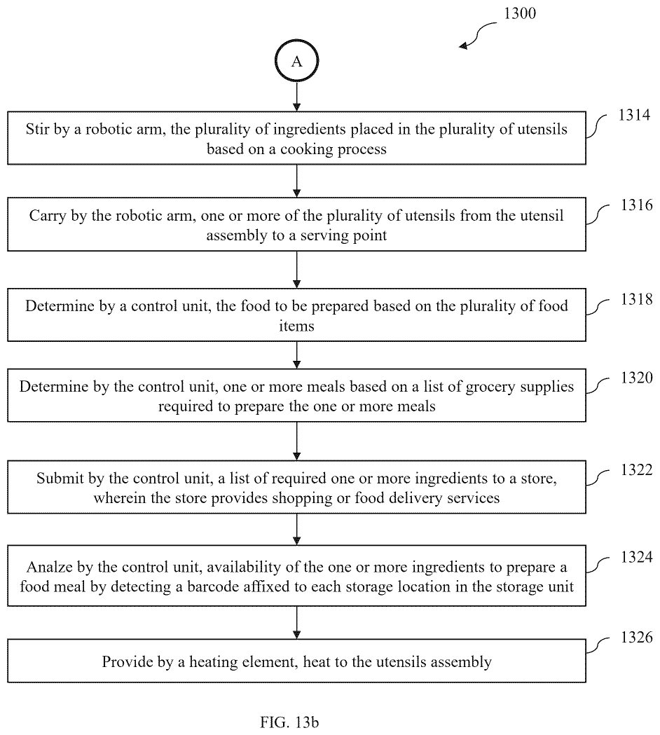

FIG. 13a and FIG. 13b illustrates a flow chart representing the steps involved in a method to operate an automated food preparation device in accordance with an embodiment of the present disclosure. The method 1300 begins at step 1302.

At step 1302, a plurality of first ingredients is stored and maintained in a refrigeration unit of a storage unit. Typically, the plurality of first ingredients are perishable food items. Examples of the plurality of first ingredients includes, but is not limited to, chicken, beef, pork, lamb, turkey, fish and seafood, dairy products, eggs, fruits and vegetables. These food items need to be refrigerated as improper storage can lead to foodborne illness.

At step 1304, a plurality of second ingredients is stored in a pantry unit of the storage unit, wherein the plurality of second ingredients are non-perishable. Non-perishable refers to ingredients that have a long shelf life and do not spoil easily even without refrigeration. Examples of the plurality of second ingredients includes, but is not limited to, grains, cereals, dried legumes, pulses, flour, dried fruits, nuts and seeds, cooking oils and fats, sugar and sweeteners, dried herbs and spices, condiments, tea and coffee.

At step 1306, food is prepared pertaining to a distinct cooking approach by a plurality of utensils. The distinct cooking approach refers to a particular method of cooking, such as frying, boiling, steaming, or grilling, depending on the recipe or type of dish being made. The preparation involves a plurality of utensils, meaning multiple tools or instruments are used during this process. Each utensil is likely designed to perform a specific task (for instance stirring, grinding, mixing) that contributes to the cooking method being employed.

In one embodiment, the distinct cooking approach includes soaking of slow cooking ingredients such as red rice, millets and legumes. This approach eliminated the need for pressure cooking.

At step 1308, hot water is allowed to flow by a water pipe. At this step, the automated food preparation device activates the flow of hot water, which could be used for a variety of purposes, such as cooking, cleaning, or heating ingredients. The water pipe is the mechanism through which the hot water is delivered. This pipe is an integral part of the device, likely designed to manage the precise flow and temperature of the water needed for the cooking or preparation process.

At step 1310, the plurality of utensil wheels are allowed to rotate and tilt around a spindle by a spindle hub. The plurality of utensil wheels are wheels that hold various utensils used in the food preparation process. Each wheel likely carries different tools (for instance stirring spoons, grinders, mixers) that are needed for cooking. The utensil wheels are allowed to rotate and tilt around a central axis called the spindle. This motion enables the utensils to move into the correct positions for performing their respective tasks, such as stirring, mixing, or grinding ingredients. The spindle hub is a key component that allows this movement to happen. It facilitates both the rotation and the tilting of the wheels, ensuring the utensils can perform various actions and adjust their positions during the cooking process.

At step 1312, an action is performed by the spindle based on a motor positioned in a lid of each of the plurality of utensils. The action refers to stirring, rotating, or engaging with the utensils in some way to aid in the cooking or preparation of the food. The action performed by the spindle is controlled or influenced by a motor that is located in the lid of each of the utensils. This motor likely provides power to control the movement or operation of the utensils, such as spinning, tilting, or stirring ingredients within the utensil. The motor in the lid works in coordination with the spindle, allowing the utensils to move or perform their cooking tasks. For example, the spindle may rotate the utensil while the motor ensures that a stirring or mixing action occurs.

At step 1314, the plurality of ingredients placed in the plurality of utensils is stirred by a robotic arm based on a cooking process. Multiple ingredients are placed into the plurality of utensils as part of the automated cooking process. These utensils likely contain different ingredients required for the recipe being prepared. The robotic arm is responsible for stirring these ingredients. The robotic arm is likely designed with precision to mix or stir ingredients evenly and efficiently, ensuring that the cooking process progresses smoothly. The stirring action is based on the specific requirements of the cooking process being used. For example, the robotic arm may stir ingredients faster or slower, or for a certain duration, depending on the recipe (for instance stirring a sauce continuously vs. gently mixing ingredients in a stew).

At step 1316, one or more of the plurality of utensils is carried from the utensil assembly to a serving point. After the cooking process, one or more of the utensils that contain the prepared food are selected to be moved. These utensils could be different sizes or types, depending on the meal or recipe. The utensils are originally part of the utensil assembly, which is the system within the automated food preparation device where the utensils are stored, manipulated, and used for cooking. The selected utensils are then carried from the utensil assembly to a designated serving point. This serving point could be a location within the device where food is plated or dispensed for serving, or it could be an external location where the user retrieves the meal.

At step 1318, the food to be prepared based on the plurality of food items is determined by a control unit. This step focuses on identifying a specific dish or meal that will be prepared. It involves analyzing the ingredients and recipes available in the storage unit. The control unit assesses a plurality of food items, which refers to the various ingredients stored in the automated food preparation device. These items may include both perishable and non-perishable ingredients that are available for cooking. The control unit manages various functions, such as recipe selection, ingredient monitoring, and cooking processes. It uses algorithms or programmed instructions to decide which food can be prepared based on the available items, ensuring that the selected meal aligns with what is currently in stock.

At step 1320, one or more meals is determined by the control unit based on a list of grocery supplies required to prepare the one or more meals. The control unit is responsible for analyzing the data regarding the ingredients on hand and determining which meals can be made. It uses predefined recipes, cooking algorithms, or machine learning models to suggest feasible meals. The control unit references a list of grocery supplies that are required for the selected meals. This list could include essential ingredients that may not currently be available in the storage unit but are necessary to complete the meal preparation. For example, if a recipe calls for chicken, vegetables, and spices, the control unit checks if these items are on hand or need to be ordered. By determining meals based on the available ingredients and required grocery supplies, the control unit helps in meal planning and inventory management. It can also facilitate grocery shopping by generating a shopping list for the ingredients that are missing.

At step 1322, a list of required one or more ingredients is submitted to a store by the control unit, wherein the store provides shopping or food delivery services. After determining which meals can be prepared, the control unit compiles a list of required one or more ingredients. This list includes all the items necessary to complete the recipes identified in the previous steps, particularly focusing on ingredients that are not currently available in the storage unit. The control unit submits this list to a store, which can be either a physical grocery store or an online grocery service. This submission can occur through an integrated system that connects the food preparation device with grocery retailers. The store mentioned in this step is equipped to provide shopping or food delivery services. This means that the store can either prepare a shopping order for the user to pick up or deliver the required ingredients directly to the user's home, enhancing convenience. This step exemplifies the automation of grocery shopping as part of the overall food preparation system. By generating and submitting a shopping list, the control unit streamlines the process of acquiring necessary ingredients, minimizing manual effort for the user.

At step 1324, availability of the one or more ingredients is analyzed by the control unit to prepare a food meal by detecting a barcode affixed to each storage location in the storage unit. The control unit evaluates whether the one or more ingredients listed as necessary for meal preparation are currently available in the storage unit. This ensures that the meal can be prepared without any missing components. The analysis is performed by the control unit, which uses its programming to systematically check the inventory of ingredients stored in the device. This step is crucial for confirming that all necessary items are on hand before starting the cooking process.

The control unit uses a barcode detection system to identify the ingredients stored in the unit. Each storage location in the storage unit is affixed with a barcode that corresponds to a specific ingredient or item. By scanning these barcodes, the control unit can quickly gather information about what ingredients are present and their quantities. Further, this step exemplifies automated inventory management within the food preparation device. By continuously checking the availability of ingredients through barcode detection, the control unit can ensure that users are aware of any shortages or the need to replenish supplies.

At step 1326, providing heat to the utensils assembly by a heating element, the heating element, which is responsible for generating and supplying heat necessary for cooking. This heat is crucial for preparing the food items within the utensils. By providing heat to the utensils assembly, this step initiates the cooking process. The applied heat allows the ingredients within the utensils to undergo chemical and physical changes, ultimately transforming them into a prepared dish.

The method ends at step 1326.

Various embodiments of the automated food preparation device provides several benefits. The automated feature reduces the time spent on meal preparation and cooking, allowing users to focus on other tasks. The control unit can suggest meals based on available ingredients, simplifying decision-making about what to cook. Further, by analyzing ingredient availability by the control unit, the automated food preparation device minimizes waste and ensures that all necessary components are used. The barcode scanning system allows for real-time inventory tracking, helping users know what ingredients they have on hand and when to restock. The system generates shopping lists based on the ingredients needed for planned meals, streamlining the grocery shopping process. Automated stirring, heating, and ingredient measurement reduce the likelihood of mistakes that can occur during manual cooking.

Further, the canister and gear mechanism allows the automated food preparation device to control the dispensing of ingredients with precision, dropping a measured amount into a utensil with each rotation of the gear. This ensures that the correct amount of ingredients is used in the cooking process, contributing to the automation and efficiency of food preparation. The inclusion of a human machine interface monitor enhances user engagement with the automated food preparation device by allowing users to input information about the ingredients they want to store, making it easier to manage and utilize the device's features effectively.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. An automated food preparation device comprising:
characterized in that,
a storage unit comprising:
a refrigeration unit adapted to store and maintain a plurality of first ingredients in a cold condition;
a pantry unit to store a plurality of second ingredients wherein the plurality of second ingredients are non-perishable;
a utensils assembly comprising:
a plurality of utensils attached to a corresponding lid for preparing food pertaining to a distinct cooking approach wherein each of the plurality of utensils is coupled to an arm of a corresponding utensil wheel and rotates about a central spindle, wherein the central spindle is used for performing at least one of grinding, stirring, closing and opening of the lid via a shutter based lid mechanism;
a water pipe adapted to allow hot water to flow, wherein the water pipe acts as a frame for supporting the plurality of utensils;
a spindle hub adapted to:
allow the plurality of utensil wheels to rotate and tilt around a spindle;
perform an action by the spindle based on a motor positioned in a lid of each of the plurality of utensils;
a robotic arm adapted to:
stir the plurality of ingredients placed in the plurality of utensils based on a cooking process;
carry one or more of the plurality of utensils from the utensil assembly to a serving point;
a control unit configured to execute on a network wherein the control unit is adapted to:
determine the food to be prepared based on the plurality of food items;
determine one or more meals based on a list of grocery supplies required to prepare the one or more meals;
submit a list of required one or more ingredients to a store, wherein the store provides shopping or food delivery services; and
analyze availability of the one or more ingredients to prepare a food meal by detecting a barcode affixed to each storage location in the storage unit;
a cooking element adapted to provide heat to the utensils assembly wherein the cooking element comprises a glass induction stove wherein the glass induction stove comprises an electric blade adapted to slide over the surface of the glass induction stove to clean the glass.

2. The automated food preparation device of claim 1, wherein the refrigeration unit and the pantry unit comprises a plurality of canisters wherein each of the plurality of canisters is adapted to store at least one of the plurality of first ingredients and the plurality of second ingredients.

3. The automated food preparation device of claim 1, further comprising a gantry with a vertical bar adapted to hold and move the plurality of canisters from the storage unit to the utensils assembly in a horizontal and vertical direction respectively.

4. The automated food preparation device of claim 1, wherein the plurality of canisters are coupled to the vertical bar via a gripper.

5. The automated food preparation device of claim 1, wherein the plurality of canisters is arranged with a gear wherein each rotation of the gear causes a predetermined volume of the ingredient to drop into a corresponding utensil.

6. The automated food preparation device of claim 1, wherein the plurality of utensil wheels are adapted to provide a tilting mechanism.

7. The automated food preparation device of claim 1, wherein the central spindle is controlled by a speed motor operated lid adapted to prevent spillage of the food from the plurality of utensils.

8. The automated food preparation device of claim 1, further comprising a human machine interface monitor adapted to:
allow a user to provide an input representative of the plurality of ingredients to be stored in the storage unit; and
allow a user to place an order for a food at a predefined time.

9. The automated food preparation device of claim 1, wherein the control unit is adapted to determine the food meal to be prepared based on the availability of the plurality of first ingredients and the plurality of second ingredients stored in the storage unit and one or more constraints specified by the user.

10. The automated food preparation device of claim 1, wherein the user is allowed to determine the food meal to be prepared based on preference.

11. The automated food preparation device of claim 1, wherein the plurality of first ingredients are moved from the plurality of refrigerator units to the pantry unit to thaw the one or more first ingredients prior to the food preparation process.

12. The automated food preparation device of claim 1, wherein the plurality of second ingredients are moved from the pantry unit to the plurality of refrigerator units to freeze after the food preparation process is complete.

13. The automated food preparation device of claim 1, further comprising:
a cleaning unit adapted to clean the plurality of canisters;
a cutting unit adapted to mince the plurality of ingredients; and
a drainage unit adapted to collect excess water from the plurality of utensils during the food preparation process and the cleaning process.

14. The automated food preparation device of claim 1, wherein the plurality of first ingredients stored in the refrigeration unit are perishable.

15. The automated food preparation device of claim 1, further comprising a plurality of food dispensers to collect the prepared food.

16. The automated food preparation device of claim 1, wherein the cooking element is a heating element.

17. The automated food preparation device of claim 3, wherein the gantry comprises a belt adapted to transport the plurality of first ingredients and the plurality of second ingredients from the storage unit to the one or more utensils for a food preparation process.

18. A method to operate an automated food preparation device comprising:
storing and maintaining, by a refrigeration unit of a storage unit, a plurality of first ingredients in a cold condition;
storing, by a pantry unit, a plurality of second ingredients wherein the plurality of second ingredients are non-perishable;
preparing, by a plurality of utensils, food pertaining to a distinct cooking approach;
allowing, by a water pipe, hot water to flow;
allowing, by a spindle hub, the plurality of utensil wheels to rotate and tilt around a spindle;
performing, by the spindle hub, an action by the spindle based on a motor positioned in a lid of each of the plurality of utensils;
stirring, by a robotic arm, the plurality of ingredients placed in the plurality of utensils based on a cooking process;
carrying, by the robotic arm, one or more of the plurality of utensils from the utensil assembly to a serving point;
determining, by a control unit, the food to be prepared based on the plurality of food items;
determining, by the control unit, one or more meals based on a list of grocery supplies required to prepare the one or more meals;
submitting, by the control unit, a list of required one or more ingredients to a store, wherein the store provides shopping or food delivery services;
analyzing, by the control unit, availability of the one or more ingredients to prepare a food meal by detecting a barcode affixed to each storage location in the storage unit; and
providing, by a heating element, heat to the utensils assembly.

19. The method of claim 1, further comprising:
cleaning, by a cleaning unit, the plurality of canisters;
mincing, by a cutting unit, the plurality of ingredients; and
collecting, by a drainage unit, excess water from the plurality of utensils during the food preparation process and the cleaning process.

20. The method of claim 1, wherein the food meal is prepared based on the availability of the plurality of first ingredients and the second ingredients and one or more constraints specified by the user.
